(19) United States
(12) Patent Application Publication
(10) Pub. No.: US 2024/0377182 A1
(43) Pub. Date: Nov. 14, 2024

(54) POSITION SENSOR

(71) Applicant: Schaeffler Technologies AG & Co. KG, Herzogenaurach (DE)

(72) Inventors: Trenton Dean, Casco, MI (US); Maximilian Bossecker, Hügelsheim (DE)

(21) Appl. No.: 18/654,789

(22) Filed: May 3, 2024

Related U.S. Application Data
(60) Provisional application No. 63/466,081, filed on May 12, 2023.

(51) Int. Cl. G01B 7/315; B62D 15/02; H02K 29/08

(52) U.S. Cl. CPC G01B 7/315; B62D 15/0225; H02K 29/08

(57) ABSTRACT

A position sensor may include an angle sensor, sensor shaft, and sensor wheel. The sensor wheel may include a first wheel-half, a second wheel-half, and a leg spring. The angle sensor may sense the rotation of the sensor shaft. The first wheel-half may be affixed to the sensor shaft. The first wheel-half may impart the rotations on the sensor shaft for sensing via a coupling with an external device, such as external threads of a ball screw nut. The second wheel-half may be supported by the sensor shaft and configured to rotate relative to the sensor shaft. The leg spring may torsionally couple the first wheel-half and the second wheel-half. The leg spring may cause the second wheel-half to an opposing lash of the external threads of the ball screw nut, thereby providing zero gear-lash.

### CROSS-REFERENCE TO RELATED APPLICATIONS

The present application claims the benefit under 35 U.S.C. § 119(e) of U.S. Provisional Application Ser. No. 63/466,081, filed May 12, 2023, titled “POSITION SENSOR”, which is incorporated herein by reference in the entirety.

### TECHNICAL FIELD

The present disclosure generally relates to a position sensor for a steering system.

### BACKGROUND

Position sensors are utilized in many vehicular systems to facilitate control and monitoring of a position of a variably displaceable component. Position sensors can provide electronic signals or feedback to electronic control units to enable such position control. Packaging and robustness are key characteristics of position sensors. Therefore, it would be advantageous to provide a device, system, and method that cures the shortcomings described above.

### SUMMARY

A position sensor is described, in accordance with one or more embodiments of the present disclosure. The position sensor may include: an angle sensor; a sensor shaft, wherein the sensor shaft is configured to rotate relative to the angle sensor, wherein the angle sensor is configured to sense rotation of the sensor shaft; a first bearing wherein the first bearing is affixed to the sensor shaft; and a sensor wheel including: a first wheel-half, wherein the first wheel-half includes a first body and first teeth, wherein the first teeth radially extend from the first body, wherein the first wheel-half is affixed to the sensor shaft, wherein the sensor shaft is configured to rotate with the first wheel-half; and a second wheel-half, wherein the second wheel-half includes a second body and second teeth, wherein the second teeth radially extend from the second body, wherein the second wheel-half is directly or indirectly supported by the sensor shaft, wherein the second wheel-half is configured to rotate relative to the sensor shaft and the first wheel-half, wherein the second wheel-half is torsionally preloaded to the first wheel-half.

In some aspects, the angle sensor including a sensor housing and a sensor sleeve, wherein the sensor sleeve is configured to rotate relative to the sensor housing, wherein the sensor sleeve is configured to sense the rotation of the sensor sleeve relative to the sensor housing, wherein the sensor shaft includes a body section, wherein the body section is affixed to the sensor sleeve.

In some aspects, the sensor shaft may include a shoulder, wherein the first bearing is affixed to the shoulder.

In some aspects, the sensor shaft may include a knurled shaft-section, wherein the first body is affixed to the knurled shaft-section.

In some aspects, the sensor shaft may include a smooth shaft-section, wherein the second body is supported by the smooth shaft-section.

In some aspects, the first wheel-half is disposed between the first bearing and the second wheel-half.

In some aspects, the first bearing is disposed between the angle sensor and the sensor wheel.

In some aspects, the sensor shaft includes a body section, a shoulder, a knurled shaft-section, and a smooth shaft-section, wherein the shoulder is disposed between the body section and the knurled shaft-section, wherein the knurled shaft-section is disposed between the shoulder and the smooth shaft-section.

In some aspects, the sensor wheel may include a leg spring, wherein the second wheel-half is torsionally preloaded to the first wheel-half through the leg spring.

In some aspects, the leg spring may include a first leg, a second leg, and a coil, wherein the coil connects the first leg and the second leg; wherein the first wheel-half defines a first coil-well, a first leg-catch, and a first travel-well, wherein the first leg-catch and the first travel-well are disposed radially outwards of the first coil-well; wherein the second wheel-half defines a second coil-well, a second leg-catch, and a second travel-well, wherein the second leg-catch and the second travel-well are disposed radially outwards of the second coil-well; wherein the first leg is abutted to the first leg-catch and disposed in the second travel-well, wherein the second leg is abutted to the second leg-catch and disposed in the first travel-well, wherein the coil is disposed in the first coil-well and the second coil-well.

In some aspects, the first travel-well includes an arcuate shape, wherein the first leg-catch is disposed between distal ends of the first travel-well; wherein the second travel-well includes an arcuate shape, wherein the second leg-catch is disposed between distal ends of the second travel-well.

In some aspects, the position sensor may include a rotational lock, wherein the rotational lock is configured to lock the second wheel-half to the first wheel-half and unlock the second wheel-half from the first wheel-half.

In some aspects, the first body defines a first lock-aperture; wherein the second body defines a second lock-aperture; wherein the second wheel-half is configured to rotate relative to the first wheel-half to align the second lock-aperture with the first lock-aperture, wherein the second teeth are aligned with the first teeth when the second lock-aperture is aligned with the first lock-aperture, wherein the rotational lock is configured to lock the second wheel-half to the first wheel-half by being disposed within the first lock-aperture and the second lock-aperture, wherein the rotational lock is configured to unlock the second wheel-half from the first wheel-half by being disposed within one of the first lock-aperture or the second lock-aperture.

In some aspects, the position sensor may include a second bearing, wherein the second bearing is supported by the sensor shaft, wherein the second wheel-half is disposed between the first wheel-half and the second bearing.

In some aspects, at least one of the first bearing or the second bearing includes one of a needle bearing, a glide bushing, a ball bearing, or a plain bearing.

In some aspects, the position sensor may include a bearing sleeve, wherein the bearing sleeve is affixed to the sensor shaft, wherein the bearing sleeve axially secures the second wheel-half, wherein the second bearing is supported by the sensor shaft via the bearing sleeve.

A road wheel actuator is described, in accordance with one or more embodiments of the present disclosure. The road wheel actuator may include: a position sensor including: an angle sensor; a sensor shaft, wherein the sensor shaft is configured to rotate relative to the angle sensor, wherein the angle sensor is configured to sense rotation of the sensor shaft; a first bearing, wherein the first bearing is affixed to the sensor shaft; and a sensor wheel including: a first wheel-half, wherein the first wheel-half includes a first body and first teeth, wherein the first teeth radially extend from the first body, wherein the first wheel-half is affixed to the sensor shaft, wherein the sensor shaft is configured to rotate with the first wheel-half; and a second wheel-half, wherein the second wheel-half includes a second body and second teeth, wherein the second teeth radially extend from the second body, wherein the second wheel-half is directly or indirectly supported by the sensor shaft, wherein the second wheel-half is configured to rotate relative to the sensor shaft and the first wheel-half, wherein the second wheel-half is torsionally preloaded to the first wheel-half; a housing; and a ball screw drive including: a ball screw spindle including external spindle-threads; and a ball screw nut including internal nut-threads, a nut-bearing, external nut-threads, and a drive section, wherein the ball screw nut is axially constrained to the housing by the nut-bearing, wherein the internal nut-threads couple to the external spindle-threads, wherein rotation of the ball screw nut causes translation of the ball screw spindle relative to the ball screw nut and the housing, wherein the external nut-threads engage the first teeth and the second teeth.

In some aspects, the road wheel actuator may include a motor and a transmission, wherein the transmission rotationally couples the motor and the drive section of the ball screw nut.

In some aspects, the drive section is disposed between the nut-bearing and the external nut-threads.

A method is described, in accordance with one or more embodiments of the present disclosure. The method may include: affixing a first bearing to a sensor shaft; affixing a first wheel-half of a sensor wheel to the sensor shaft, wherein the first wheel-half includes a first body and first teeth, wherein the first teeth radially extend from the first body, wherein the sensor shaft is configured to rotate with the first wheel-half; inserting a second wheel-half of the sensor wheel onto the sensor shaft, wherein the second wheel-half includes a second body and second teeth, wherein the second teeth radially extend from the second body, wherein the second wheel-half is directly or indirectly supported by the sensor shaft, wherein the second wheel-half is configured to rotate relative to the sensor shaft and the first wheel-half, wherein the second wheel-half is torsionally preloaded to the first wheel-half; and inserting the sensor shaft within an angle sensor to form a position sensor, wherein the sensor shaft is configured to rotate relative to the angle sensor, wherein the angle sensor is configured to sense rotation of the sensor shaft.

### BRIEF DESCRIPTION OF THE DRAWINGS

The numerous advantages of the disclosure may be better understood by those skilled in the art by reference to the accompanying figures in which:

FIG. 1A illustrates a perspective view of a position sensor, in accordance with one or more embodiments of the present disclosure.

FIG. 1B illustrates a cross-section view of the position sensor, in accordance with one or more embodiments of the present disclosure.

FIG. 1C illustrates an exploded view of the position sensor, in accordance with one or more embodiments of the present disclosure.

FIG. 1D illustrates a partial exploded view of a sensor wheel of the position sensor, in accordance with one or more embodiments of the present disclosure.

FIG. 1E illustrates an additional cross-section view through a different angle of the position sensor with an angle sensor of the position sensor which is hidden, in accordance with one or more embodiments of the present disclosure.

FIG. 2 illustrates a flow diagram of a method of assembling the position sensor, in accordance with one or more embodiments of the present disclosure.

FIG. 3A illustrates an inner ring of a bearing affixed to a shoulder of a sensor shaft, in accordance with one or more embodiments of the present disclosure.

FIG. 3B illustrates a first wheel-half affixed to a knurled shaft-section of the sensor shaft and a leg spring inserted within a first body of the first wheel-half, in accordance with one or more embodiments of the present disclosure.

FIG. 3C illustrates a second wheel-half inserted onto the sensor shaft such that the leg spring is inserted within a second body of the second wheel-half, thereby torsionally coupling the first wheel-half and the second wheel-half, in accordance with one or more embodiments of the present disclosure.

FIG. 3D illustrates a bearing sleeve affixed to the sensor shaft, in accordance with one or more embodiments of the present disclosure.

FIG. 3E illustrates a first lock-aperture of the first wheel-half aligned with a second lock-aperture of the second wheel-half by rotating the second wheel-half relative to the first wheel-half, in accordance with one or more embodiments of the present disclosure.

FIG. 3F illustrates locking the second wheel-half to the first wheel-half by a rotational lock, in accordance with one or more embodiments of the present disclosure.

FIG. 3G illustrates a bearing affixed to the bearing sleeve, in accordance with one or more embodiments of the present disclosure.

FIG. 4A illustrates a perspective view of a road wheel actuator, in accordance with one or more embodiments of the present disclosure.

FIG. 4B illustrates a cross section view of the road wheel actuator with the position sensor and a ball screw drive, in accordance with one or more embodiments of the present disclosure.

FIG. 4C illustrates a perspective view of the position sensor and the ball screw drive of the road wheel actuator, in accordance with one or more embodiments of the present disclosure.

FIG. 4D illustrates a cross section view of the position sensor and the ball screw drive of the road wheel actuator, in accordance with one or more embodiments of the present disclosure.

FIG. 4E illustrates a side view of the position sensor and the ball screw drive of the road wheel actuator, in accordance with one or more embodiments of the present disclosure.

FIG. 4F illustrates a cross section view of the position sensor and the ball screw drive of the road wheel actuator, in accordance with one or more embodiments of the present disclosure.

FIG. 5 illustrates a flow diagram of installing the position sensor in the road wheel actuator, in accordance with one or more embodiments of the present disclosure.

FIG. 6A illustrates installing the position sensor within the housing, in accordance with one or more embodiments of the present disclosure.

FIG. 6B illustrates unlocking the sensor wheel by driving the rotational lock into a first lock-aperture of a first wheel-half, in accordance with one or more embodiments of the present disclosure.

FIG. 6C illustrates plugging a bore of a housing, in accordance with one or more embodiments of the present disclosure.

FIG. 7 illustrates a cross section view of the road wheel actuator with the position sensor and the ball screw drive, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for applications or implementations.

Embodiments of the present disclosure are directed to a position sensor. The position sensor may be a zero-lash worm gear sensor. The position sensor may include an angle sensor, sensor shaft, and sensor wheel. The sensor wheel may include a first wheel-half, a second wheel-half, and a leg spring. The angle sensor may sense the rotation of the sensor shaft. The first wheel-half may be affixed to the sensor shaft. The first wheel-half may impart the rotations on the sensor shaft for sensing via a coupling with an external device, such as external threads of a ball screw nut. The second wheel-half may be directly or indirectly supported by the sensor shaft and configured to rotate relative to the sensor shaft. The leg spring may torsionally couple the first wheel-half and the second wheel-half. The leg spring may cause the second wheel-half to an opposing lash of the external threads of the ball screw nut, thereby providing zero gear-lash.

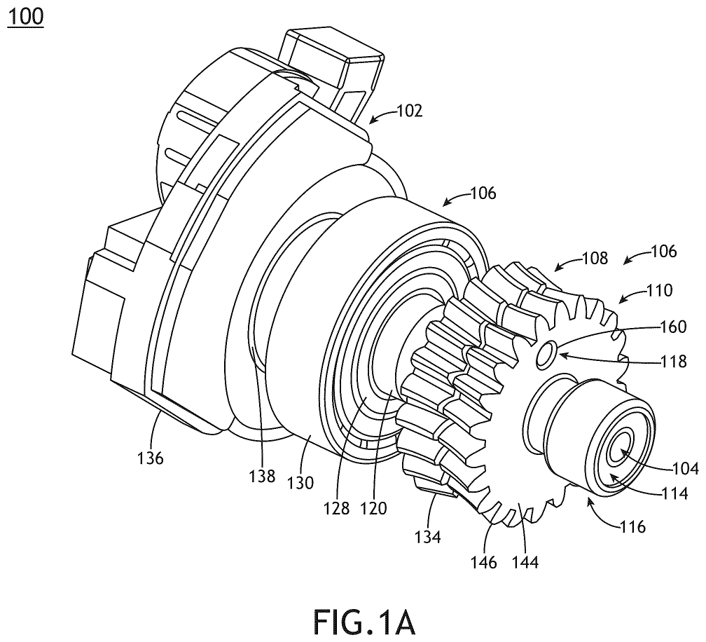

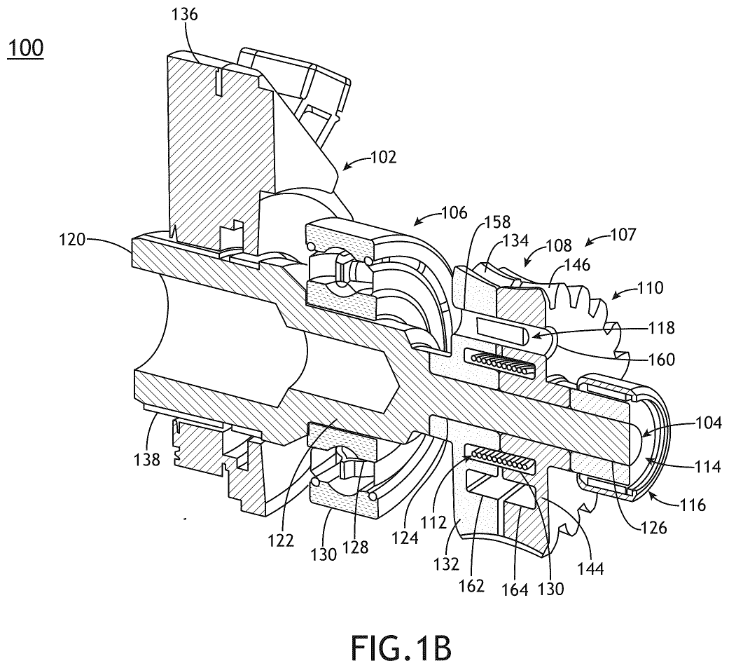

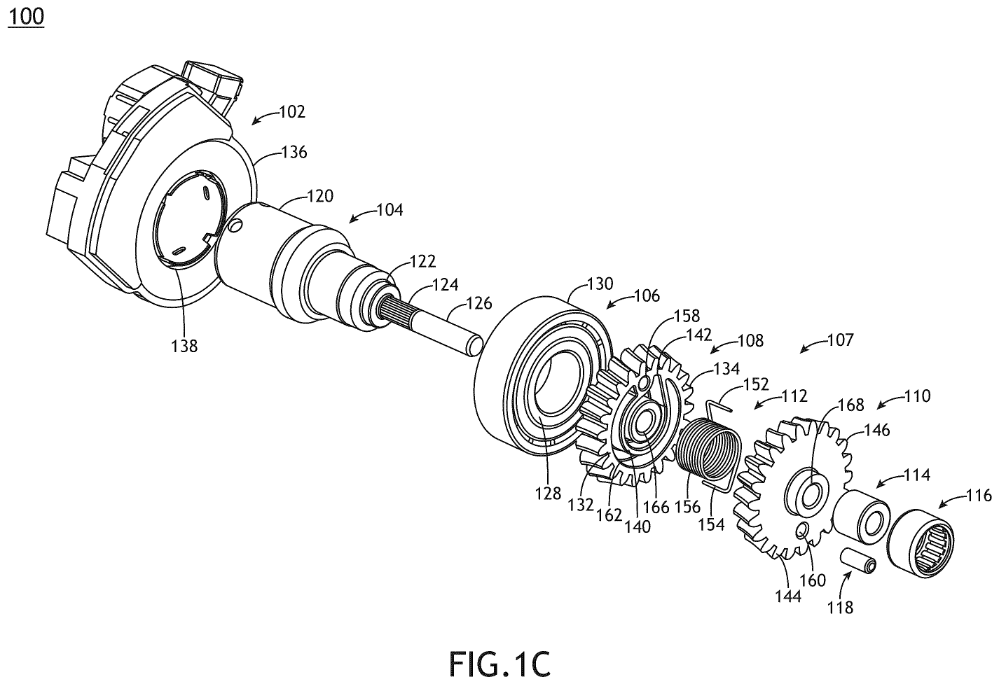

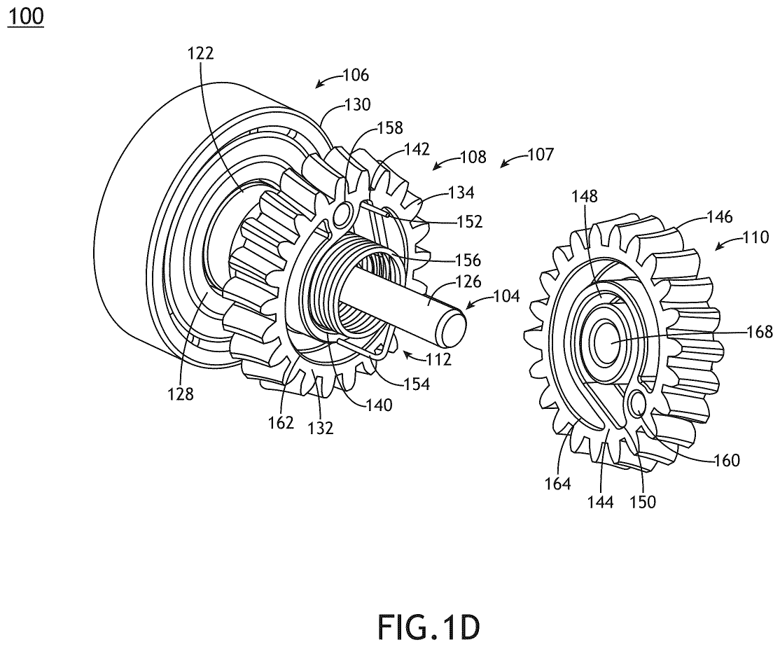

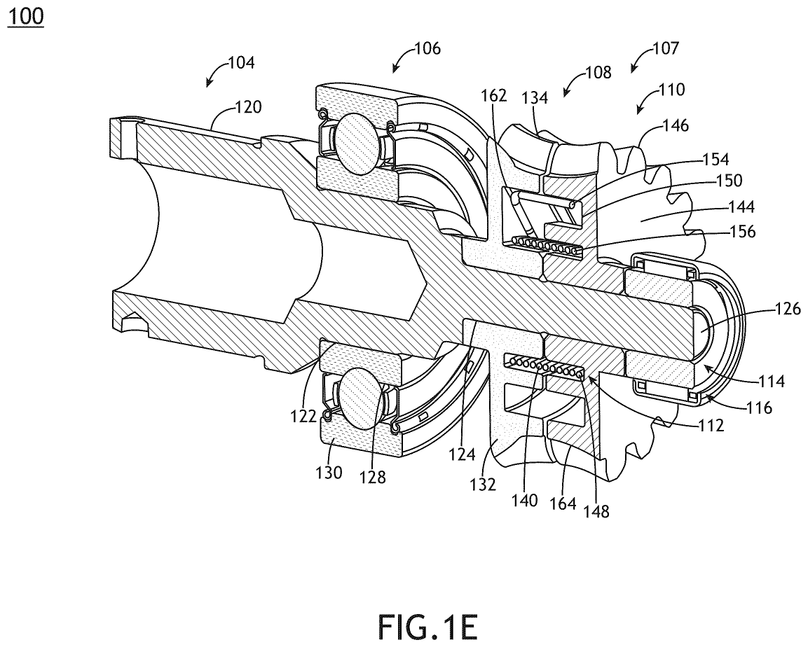

FIGS. 1A-1E illustrate a position sensor 100, in accordance with one or more embodiments of the present disclosure. The position sensor 100 may include one or more of an angle sensor 102, a sensor shaft 104, a bearing 106, a sensor wheel 107, a first wheel-half 108, a second wheel-half 110, a leg spring 112, a bearing sleeve 114, a bearing 116, and/or a rotational lock 118.

The angle sensor 102 may be an angular position sensor, a rotary position sensor, or the like. The angle sensor 102 may include a sensor housing 136 and a sensor sleeve 138. The sensor sleeve 138 may be configured to rotate relative to the sensor housing 136. The sensor housing 136 may be configured to sense the rotation of the sensor sleeve 138 relative to the sensor housing 136. The sensor housing 136 may include one or more sensor electronics for sensing the rotation. Rotation of the sensor sleeve 138 may induce a magnetic field. The angle sensor 102 may sense of the angular position of the sensor shaft 104 via the magnetic field.

The sensor shaft 104 may include one or more of a body section 120, a shoulder 122, a knurled shaft-section 124, and/or a smooth shaft-section 126. The body section 120 may define a first end of the sensor shaft 104. The shoulder 122 may be disposed between the knurled shaft-section 124 and the body section 120. The knurled shaft-section 124 may be disposed between the shoulder 122 and the smooth shaft-section 126. The smooth shaft-section 126 may define a second end of the sensor shaft 104. The body section 120 and the smooth shaft-section 126 may define opposing ends of the sensor shaft 104.

The body section 120 may be received within the angle sensor 102. The sensor shaft 104 may be affixed to the angle sensor 102. For example, the body section 120 may be affixed to the angle sensor 102. For instance, the body section 120 may be affixed to the sensor sleeve 138. The body section 120 may be affixed to the sensor sleeve 138 using one or more pins, crimps, grubscrews, or the like.

The sensor shaft 104 may be configured to rotate relative to the angle sensor 102. For example, the sensor shaft 104 may be configured to rotate relative to the sensor housing 136. The sensor shaft 104 may rotate with the sensor sleeve 138 relative to the sensor housing 136. The angle sensor 102 may sense rotation of the sensor shaft 104. The sensor housing 136 may sense the rotation of the sensor shaft 104 relative to the sensor housing 136. The sensor housing 136 may include sensor electronics which, in conjunction with features or components of the sensor shaft 104 (such as a magnet) and/or the sensor sleeve 138, sense the rotational angle of the sensor shaft 104.

The bearing 106 may be referred to as a first bearing. The bearing 106 may include a needle bearing, a glide bushing, a ball bearing, a plain bearing (e.g., a bushing), or the like. For example, the bearing 106 is depicted as a ball bearing.

The bearing 106 may include an inner ring 128, an outer ring 130, balls (not depicted), a cage, and the like. The inner ring 128 and the outer ring 130 may be disposed around a central axis of the bearing 106. The inner ring 128 and the outer ring 130 may be a radially outer ring and a radially inner ring, respectively. The outer ring 130 may be configured to rotate relative to the inner ring 128. The relative rotation between the outer ring 130 and the inner ring 128 may occur about the central axis of the bearing 106. The balls of the bearing 106 may maintain rolling contact between the outer ring 130 and the inner ring 128.

The bearing 106 may be disposed between the angle sensor 102 and the sensor wheel 107. For example, the bearing 106 may be disposed between the angle sensor 102 and the first wheel-half 108 and/or the second wheel-half 110.

The bearing 106 may be affixed to the sensor shaft 104. For example, the inner ring 128 of the bearing 106 may be affixed to the sensor shaft 104. For instance, the inner ring 128 of the bearing 106 may be affixed to the shoulder 122 of the sensor shaft 104. The inner ring 128 of the bearing 106 may be prevented from rotating relative to the sensor shaft 104 by being affixed to the sensor shaft 104. The inner ring 128 of the bearing 106 may be affixed to the sensor shaft 104 by a press-fit, a keyway, a grubscrew, or the like. For example, the inner ring 128 of the bearing 106 may be affixed to the sensor shaft 104 by press-fit onto the shoulder 122.

The outer ring 130 of the bearing 106 may be configured to rotate relative to the sensor shaft 104 via the inner ring 128.

The sensor wheel 107 may be a torsionally resilient wheel. The sensor wheel 107 may include the first wheel-half 108, the second wheel-half 110, and the leg spring 112. For example, the sensor wheel 107 may be an assembly of the first wheel-half 108, the second wheel-half 110, and the leg spring 112. The sensor wheel 107 may be a scissor gear with the first wheel-half 108 and the second wheel-half 110.

The first wheel-half 108 and the second wheel-half 110 may be constructed from a selected material, such as a plastic. The plastic may have a low coefficient of friction.

The first wheel-half 108 may be disposed between the bearing 106 and the second wheel-half 110.

The first wheel-half 108 may include a first body 132 and first teeth 134. The first teeth 134 may radially extend from the first body 132. The first wheel-half 108 may define a first coil-well 140, a first leg-catch 142, a first lock-aperture 158, and/or a first travel-well 162. For example, the first body 132 may define the first coil-well 140, the first leg-catch 142, the first lock-aperture 158, the first travel-well 162, and/or the first shaft-hole 166.

The first coil-well 140, the first leg-catch 142, the first lock-aperture 158, the first travel-well 162, and/or the first shaft-hole 166 may be disposed radially inwards of the first teeth 134. The first leg-catch 142, the first lock-aperture 158, and/or the first travel-well 162 may be disposed radially outwards of the first coil-well 140. The first lock-aperture 158 may be disposed adjacent to the first leg-catch 142. The first travel-well 162 may include an arcuate shape. The first leg-catch 142 and/or the first lock-aperture 158 may be disposed between distal ends of the first travel-well 162. The first shaft-hole 166 may be disposed at a center of the first wheel-half 108. The first lock-aperture 158 and/or the first shaft-hole 166 may be through holes. A diameter of the first lock-aperture 158 may be less than a diameter of the first shaft-hole 166.

The first wheel-half 108 may be affixed to the sensor shaft 104. For example, the first body 132 of the first wheel-half 108 may be affixed to the sensor shaft 104. For instance, the first body 132 of the first wheel-half 108 may be affixed to the knurled shaft-section 124 of the sensor shaft 104. The first shaft-hole 166 defined by the first body 132 may receive the sensor shaft 104. The first wheel-half 108 may be affixed to the sensor shaft 104 by a press-fit, a keyway, a grubscrew, or the like. For example, the first wheel-half 108 may be affixed to the sensor shaft 104 by press-fit onto the knurled shaft-section 124.

The first wheel-half 108, the sensor shaft 104, and the sensor sleeve 138 may be affixed together. The sensor shaft 104 may rotate with first wheel-half 108. Relative rotations of the first wheel-half 108 may be translated through the sensor shaft 104 for sensing by the angle sensor 102. The angle sensor 102 may sense the rotation of the first wheel-half 108, the sensor shaft 104, and/or the sensor sleeve 138.

The second wheel-half 110 may be disposed between the first wheel-half 108 and one or more of the bearing sleeve 114 and/or the bearing 116.

The second wheel-half 110 may include a second body 144 and second teeth 146. The second teeth 146 may radially extend from the second body 144. The second wheel-half 110 may define a second coil-well 148, a second leg-catch 150, a second lock-aperture 160, a second travel-well 164, and/or a second shaft-hole 168. For example, the second body 144 may define the second coil-well 148, the second leg-catch 150, the second lock-aperture 160, the second travel-well 164, and/or the second shaft-hole 168.

The second coil-well 148, the second leg-catch 150, the second lock-aperture 160, the second travel-well 164, and/or the second shaft-hole 168 may be disposed radially inwards of the second teeth 146. The second leg-catch 150, the second lock-aperture 160, and/or the second travel-well 164 may be disposed radially outwards of the second coil-well 148. The second lock-aperture 160 may be disposed adjacent to the second leg-catch 150. The second travel-well 164 may include an arcuate shape. The second leg-catch 150 and/or the second lock-aperture 160 may be disposed between distal ends of the second travel-well 164. The first shaft-hole 166 may be disposed at a center of the first wheel-half 108. The second lock-aperture 160 and/or the second shaft-hole 168 may be through holes. A diameter of the second lock-aperture 160 may be less than a diameter of the second shaft-hole 168.

The second wheel-half 110 may be directly or indirectly supported by the sensor shaft 104. The second wheel-half 110 may be supported directly by the sensor shaft 104. For example, the second body 144 of the second wheel-half 110 may be supported by the sensor shaft 104. For instance, the second body 144 of the second wheel-half 110 may be supported by the smooth shaft-section 126 of the sensor shaft 104. The second shaft-hole 168 defined by the second body 144 may receive the sensor shaft 104. The second wheel-half 110 may be supported by the sensor shaft 104 with one-degree of freedom. The second wheel-half 110 and the sensor shaft 104 may form a revolute joint. The second wheel-half 110 may be configured to rotate relative to the sensor shaft 104 and/or the first wheel-half 108. The second wheel-half 110 may include a clearance fit with the sensor shaft 104 by which the second wheel-half 110 is configured to rotate relative to the sensor shaft 104 and/or the first wheel-half 108.

It is further contemplated that the second wheel-half 110 may be supported indirectly (not depicted) by the sensor shaft 104. For example, the first wheel-half 108 may directly support the second wheel-half 110 and the sensor shaft 104 may directly support the first wheel-half 108. Thus, the second wheel-half 110 may be supported indirectly by the sensor shaft 104 through the first wheel-half 108.

The first teeth 134 and the second teeth 146 may be configured as a toothed gearing. For example, the first teeth 134 and the second teeth 146 may be configured with worm gearing. The worm gearing may include helical teeth.

The first teeth 134 and the second teeth 146 may include a selected number of teeth, pressure angle, pitch, tooth thickness, tip diameter, root diameter, reference diameter, and the like. It is contemplated that the specific values of the selected number of teeth, pressure angle, pitch, tooth thickness, tip diameter, root diameter, and/or the reference diameter may be selected to provide a desired angular resolution when sensing the rotation of the sensor shaft 104, by providing smaller or coarser turns of the sensor wheel 107. The first teeth 134 and the second teeth 146 are depicted as including twenty-two teeth, although this is not intended as a limitation of the present disclosure. The pressure angle may be between 12° and 28°.

The leg spring 112 may be a torsion spring. The leg spring 112 may include a first leg 152, a second leg 154, and a coil 156. The coil 156 may connect between the first leg 152 and the second leg 154.

The first leg 152 of the leg spring 112 may be abutted to the first leg-catch 142 defined by the first body 132 of the first wheel-half 108 and may be disposed within the second travel-well 164 defined by the second body 144 of the second wheel-half 110. The second leg 154 of the leg spring 112 may be abutted to the second leg-catch 150 defined by the second body 144 of the second wheel-half 110 and may be disposed within the first travel-well 162 defined by the first body 132 of the first wheel-half 108. The coil 156 may be disposed within the first coil-well 140 defined by the first body 132 of the first wheel-half 108 and/or disposed within the second coil-well 148 defined by the second body 144 of the second wheel-half 110.

The leg spring 112 may couple the first wheel-half 108 and the second wheel-half 110. The leg spring 112 may couple the first wheel-half 108 and the second wheel-half 110 by the first leg 152 abutting the first leg-catch 142 and the second leg 154 abutting the second leg-catch 150.

The first leg 152 of the leg spring 112 may travel within the second travel-well 164 defined by the second body 144 of the second wheel-half 110 while remaining abutted to the first leg-catch 142 defined by the first body 132 of the first wheel-half 108 as the second wheel-half 110 rotates relative to the first wheel-half 108. Similarly, the second leg 154 of the leg spring 112 may travel within the first travel-well 162 defined by the first body 132 of the first wheel-half 108 while remaining abutted to the second leg-catch 150 defined by the second body 144 of the second wheel-half 110 as the second wheel-half 110 rotates relative to the first wheel-half 108.

The rotation of the second wheel-half 110 relative to the first wheel-half 108 may torsionally load and/or unload the leg spring 112. For example, the rotation of the second wheel-half 110 relative to the first wheel-half 108 may torsionally load and/or unload the coil 156 of the leg spring 112. The coil 156 of the leg spring 112 may be disposed within the first coil-well 140 of the first wheel-half 108 such that the first leg 152 may be abutted to the first leg-catch 142 to torsionally lock the leg spring 112 to the first wheel-half 108. The coil 156 of the leg spring 112 may be disposed within the second coil-well 148 and the second leg 154 of the leg spring 112 may be abutted to the second leg-catch 150 to torsionally lock the leg spring 112 to the second wheel-half 110.

The second wheel-half 110 may be torsionally preloaded to the first wheel-half 108. The second wheel-half 110 may be torsionally preloaded to the first wheel-half 108 such that the first wheel-half 108 and the second wheel-half 110 tend to rotate in opposite directions. The second wheel-half 110 may be torsionally preloaded to the first wheel-half 108 through the leg spring 112. The coil 156 of the leg spring 112 may be pre-loaded between the first wheel-half 108 and the second wheel-half 110 causing the first wheel-half 108 and the second wheel-half 110 to rotate in opposite directions.

The coil 156 may include a spring rate. The spring rate of the coil 156 may control the torsional preload from the second wheel-half 110 to the first wheel-half 108. The spring rate and/or the torsional preload may be selected based on a desired application of the position sensor 100.

The second lock-aperture 160 of the second wheel-half 110 may be aligned with the first lock-aperture 158 of the first wheel-half 108. The second wheel-half 110 may be configured to rotate relative to the first wheel-half 108 to align the second lock-aperture 160 with the first lock-aperture 158. The alignment of the first lock-aperture 158 with the second lock-aperture 160 may load the leg spring 112 in torsion. The alignment of the second lock-aperture 160 of the second wheel-half 110 with the first lock-aperture 158 of the first wheel-half 108 may pre-load the leg spring 112 and/or align the second teeth 146 of the second wheel-half 110 to the first teeth 134 of the first wheel-half 108.

The second teeth 146 may be aligned with the first teeth 134 when the second lock-aperture 160 is aligned with the first lock-aperture 158. Aligning the second teeth 146 with the first teeth 134 may be beneficial for assembly of the position sensor 100 in a steering system.

The rotational lock 118 may be a grub screw, a set screw, a threaded screw, or the like. The rotational lock 118 may be disposed within the first lock-aperture 158 of the first wheel-half 108 and/or the second lock-aperture 160 of the second wheel-half 110.

The rotational lock 118 may lock the second wheel-half 110 to the first wheel-half 108 and unlock the second wheel-half 110 from the first wheel-half 108. For example, the rotational lock 118 may lock the second wheel-half 110 to the first wheel-half 108 by being disposed within the first lock-aperture 158 of the first wheel-half 108 and the second lock-aperture 160 of the second wheel-half 110. The rotational lock 118 may then prevent relative rotation between first wheel-half 108 and the second wheel-half 110. By way of another example, the rotational lock 118 may be disposed within one of the first lock-aperture 158 of the first wheel-half 108 or the second lock-aperture 160 of the second wheel-half 110. The rotational lock 118 may then allow relative rotation between first wheel-half 108 and the second wheel-half 110.

The rotational lock 118 may include one or more threads (not depicted). The one or more thread may cut into the first lock-aperture 158 and/or the second lock-aperture 160.

The bearing sleeve 114 may be affixed to the sensor shaft 104. For example, the bearing sleeve 114 may be affixed to the smooth shaft-section 126 of the sensor shaft 104. The bearing sleeve 114 may be prevented from rotating relative to the sensor shaft 104 by being affixed to the sensor shaft 104. The bearing sleeve 114 may be affixed to the sensor shaft 104 by a press-fit, a keyway, a grubscrew, or the like. For example, the bearing sleeve 114 may be affixed to the sensor shaft 104 by press-fit onto the end of the sensor shaft 104.

The bearing sleeve 114 may axially secure the second wheel-half 110. For example, the bearing sleeve 114 may axially secure the second wheel-half 110 with one-degree of freedom. The second wheel-half 110 and the bearing sleeve 114 may form a revolute joint. The second wheel-half 110 may be configured to rotate relative to the bearing sleeve 114.

The bearing 116 may be referred to as a second bearing. The bearing 116 may be supported by the sensor shaft 104. For example, the bearing sleeve 114 may be supported by the smooth shaft-section 126 of the sensor shaft 104. For instance, the bearing 116 may be supported by the sensor shaft 104 via the bearing sleeve 114.

The bearing 116 may include a needle bearing, a glide bushing, a ball bearing, a plain bearing (e.g., a bushing), or the like. For example, the bearing 116 is depicted as the needle bearing. An inner race of the needle bearing may be affixed to the needle bearing. An outer race of the needle bearing may be configured to rotate relative to the inner race of the needle bearing.

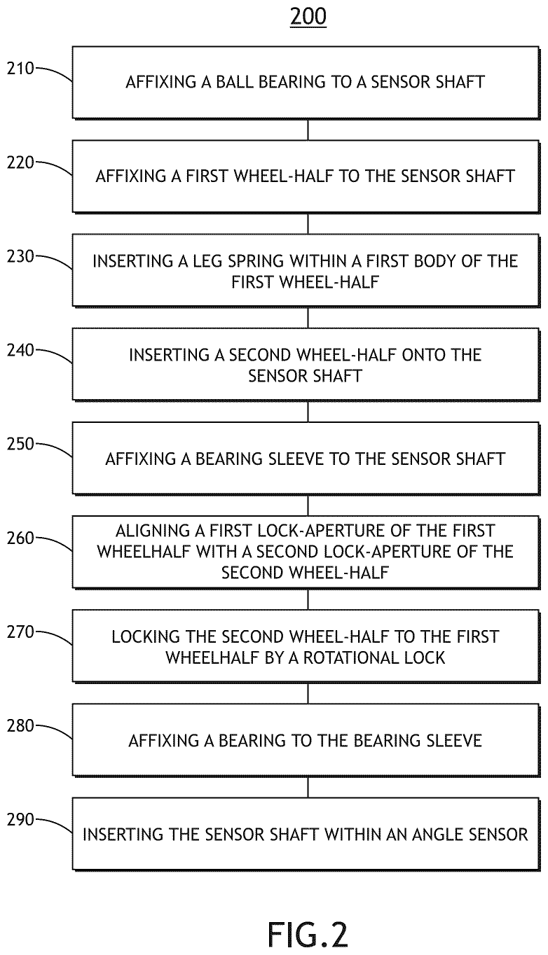

FIG. 2 illustrates a flow diagram of a method 200, in accordance with one or more embodiments of the present disclosure. The method 200 provides a method for assembling the position sensor 100. The embodiments and the enabling technology described previously herein in the context of the position sensor 100, should be interpreted to extend to the method. It is further recognized, however, that the method is not limited to the position sensor 100.

In a step 210, a bearing may be affixed to a sensor shaft. For example, the bearing 106 may be affixed to the sensor shaft 104. The inner ring 128 of the bearing 106 may be affixed to the shoulder 122 of the sensor shaft 104. The inner ring 128 of the bearing 106 may be affixed by pressing onto the shoulder 122 of the sensor shaft 104

In a step 220, a first wheel-half may be affixed to the sensor shaft. For example, the first wheel-half 108 may be affixed to the sensor shaft 104. The first wheel-half 108 may be affixed to knurled shaft-section 124 of the sensor shaft 104. The first wheel-half 108 may be affixed by pressing onto the knurled shaft-section 124 of the sensor shaft 104.

In a step 230, a leg spring may be inserted within a first body of the first wheel-half 108. For example, the leg spring 112 may be inserted within the first body 132 of the first wheel-half 108. The leg spring 112 may be inserted within the first body 132 of the first wheel-half 108 such that the first leg 152 may abut the first leg-catch 142, the coil 156 may be disposed within the first coil-well 140, and the second leg 154 may be disposed within the first travel-well 162. The first leg 152 may abut first leg-catch 142 to torsionally lock the leg spring 112 to the first wheel-half 108.

In a step 240, a second wheel-half may be inserted onto the sensor shaft. For example, the second wheel-half 110 may be inserted onto the sensor shaft 104. The second wheel-half 110 may be inserted onto the sensor shaft 104 such that the second wheel-half 110 is directly or indirectly supported by the sensor shaft 104 and may rotate relative to the sensor shaft 104 and/or the first wheel-half 108. The second body 144 of the second wheel-half 110 may be inserted onto the sensor shaft 104. The second shaft-hole 168 defined by the second body 144 may be inserted onto the sensor shaft 104. The second shaft-hole 168 defined by the second body 144 may be inserted onto the smooth shaft-section 126 of the sensor shaft 104.

The leg spring 112 may be inserted within the second body 144 of the second wheel-half 110 as the second wheel-half 110 is inserted onto the sensor shaft 104. The leg spring 112 may be inserted within the second body 144 of the second wheel-half 110 such that the second leg 154 may abut the second leg-catch 150, the coil 156 may be disposed within the second coil-well 148, and the first leg 152 may be disposed within the second travel-well 164. The second leg 154 may abut the second leg-catch 150 to torsionally lock the leg spring 112 to the second wheel-half 110. The leg spring 112 may now torsionally couple the first wheel-half 108 and the second wheel-half 110.

The leg spring 112 may be in an unloaded state after being inserted within the second body 144. The unloaded state may be an unstressed state, un-tensioned state, or the like.

In a step 250, a bearing sleeve may be affixed to the sensor shaft. For example, the bearing sleeve 114 may be affixed to the sensor shaft 104. The bearing sleeve 114 may be affixed to an end of the smooth shaft-section 126. The bearing sleeve 114 may be affixed to by pressing onto the end of the smooth shaft-section 126. The second wheel-half 110 may be axially secured on the sensor shaft 104 via the bearing sleeve 114.

In a step 260, a first lock-aperture of the first wheel-half may be aligned with a second lock-aperture of the second wheel-half by rotating the second wheel-half relative to the first wheel-half. For example, the first lock-aperture 158 of the first wheel-half 108 may be aligned with the second lock-aperture 160 of the second wheel-half 110 by rotating the second wheel-half 110 relative to the first wheel-half 108. The second wheel-half 110 is rotated on the sensor shaft 104 relative to the first wheel-half 108 until the second lock-aperture 160 of the second wheel-half 110 is aligned with the first lock-aperture 158 of the first wheel-half 108.

The rotation of the second wheel-half 110 may load the leg spring 112 and aligns second teeth 146 of the second wheel-half 110 to the first teeth 134 of the first wheel-half 108. Aligning the first lock-aperture 158 with the second lock-aperture 160 may load the coil 156 of the leg spring 112.

In a step 270, the second wheel-half may be locked to the first wheel-half by a rotational lock. For example, the second wheel-half 110 may be locked to the first wheel-half 108 by the rotational lock 118. The rotational lock 118 may be inserted within the first lock-aperture 158 and the second lock-aperture 160, thereby locking the second wheel-half 110 may be locked to the first wheel-half 108 by the rotational lock 118.

The rotational lock 118 may be driven into the second lock-aperture 160 of the second wheel-half 110 to engage the first lock-aperture 158 of the first wheel-half 108. The rotational lock 118 may include threads that cut into the first lock-aperture 158 of the first wheel-half 108 and/or the second lock-aperture 160 of the second wheel-half 110. The rotational lock 118 may cut threading into the first lock-aperture 158 and/or the second lock-aperture 160 thus maintaining a tight fit. The rotational lock 118 may be driven by a pushrod type tool, a spall screw driver, or the like.

In a step 280, a bearing may be affixed to the bearing sleeve. For example, the bearing 116 may be affixed to the bearing sleeve 114. The bearing 116 may be affixed to the bearing sleeve 114 by pressing the bearing sleeve 114 in combination with the assembly including the sensor shaft 104, the bearing 106, the first wheel-half 108, the second wheel-half 110, the leg spring 112, the bearing sleeve 114, and/or the rotational lock 118 onto the bearing 116.

In a step 290, the sensor shaft may be inserted within an angle sensor. For example, the sensor shaft 104 may be inserted within the angle sensor 102. The body section 120 of the sensor shaft 104 may be inserted within and affixed to the sensor sleeve 138 of the angle sensor 102. Inserting the sensor shaft 104 to the angle sensor 102 may form the position sensor 100.

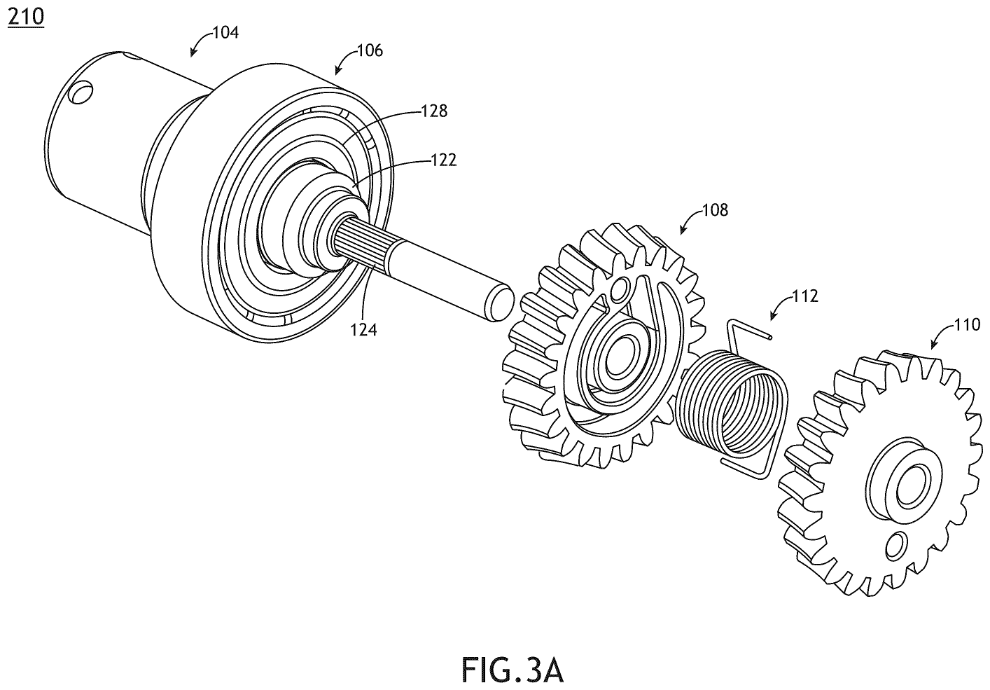

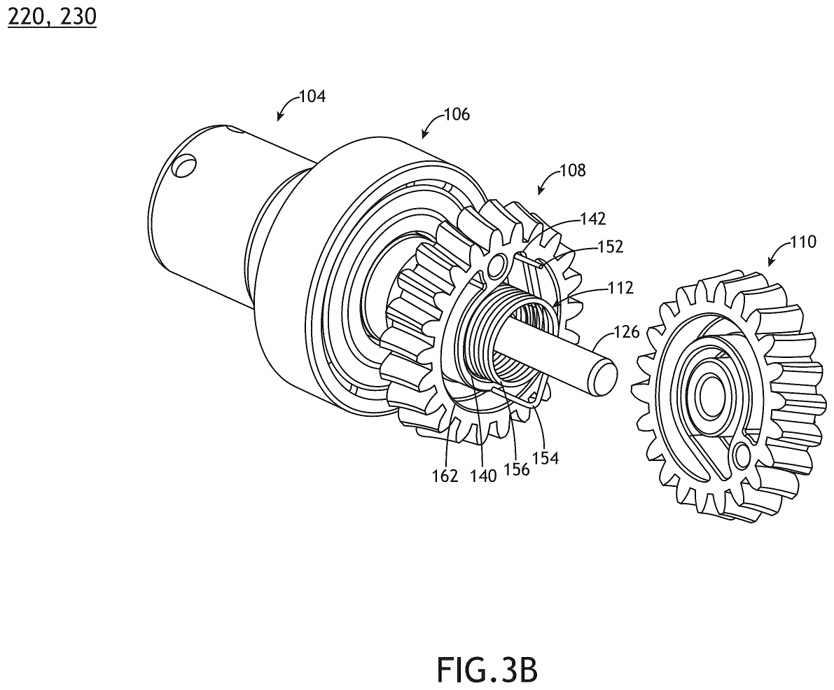

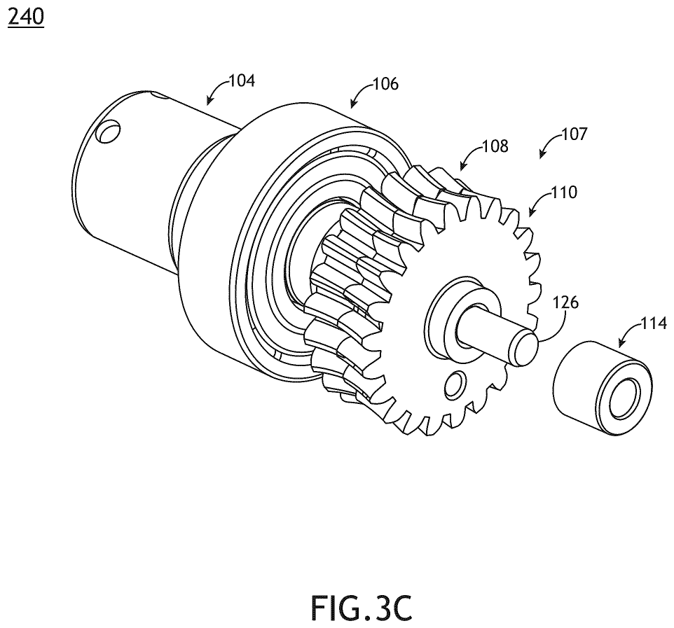

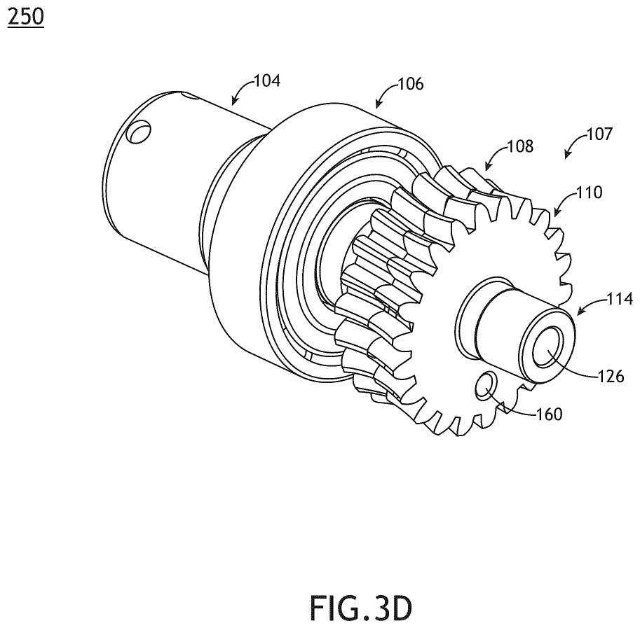

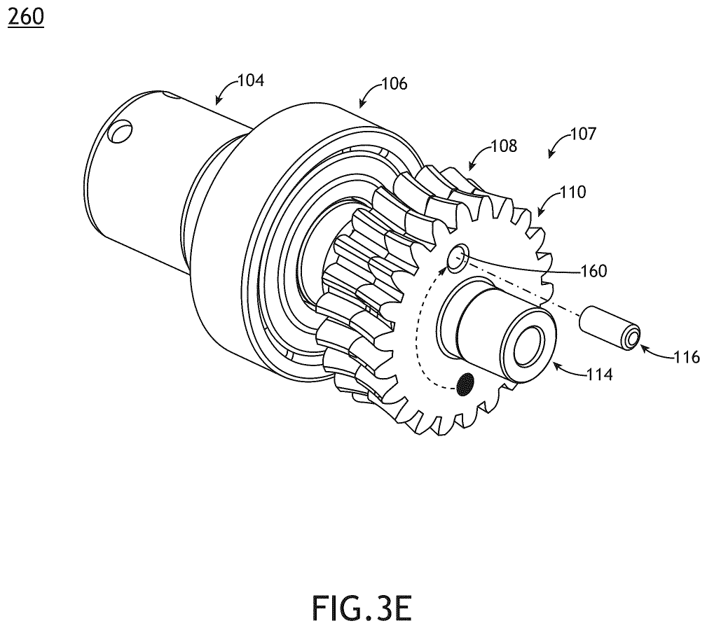

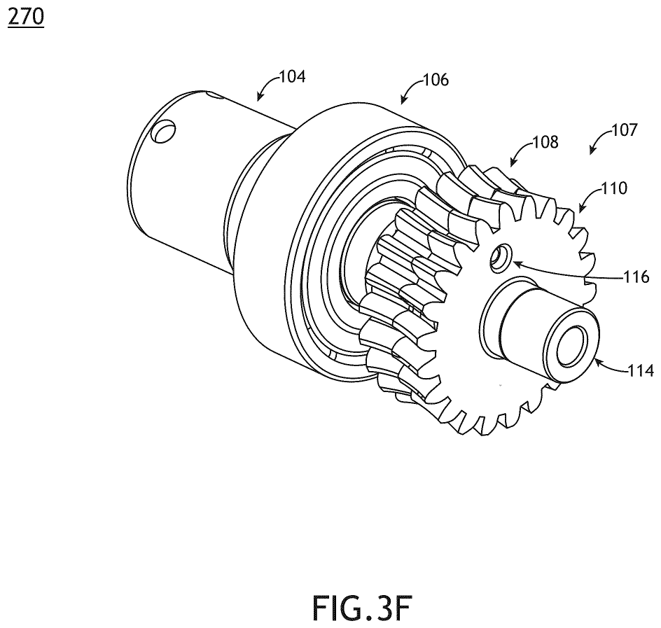

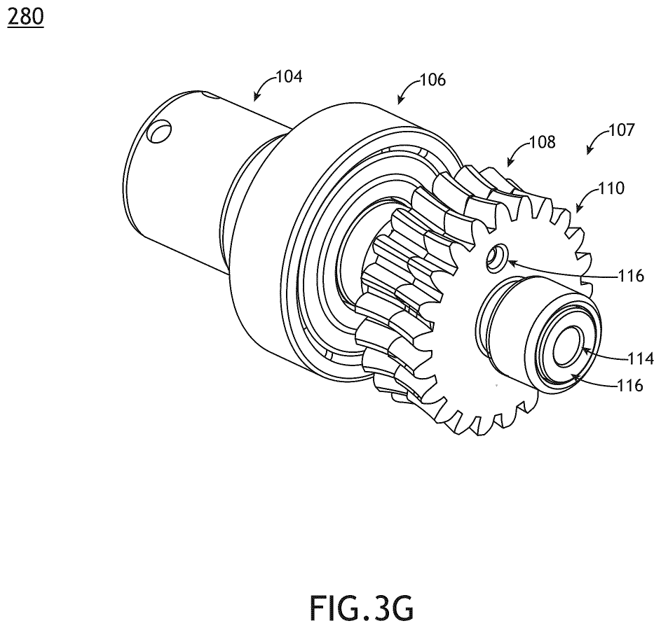

The method 200 may be further understood with reference to FIGS. 3A-3G. FIG. 3A illustrates the inner ring 128 of the bearing 116 affixed to the shoulder 122 of the sensor shaft 104. FIG. 3B illustrates the first wheel-half 108 affixed to the knurled shaft-section 124 of the sensor shaft 104 and the leg spring 112 inserted within the first body 132 of the first wheel-half 108. FIG. 3C illustrates the second wheel-half 110 inserted onto the sensor shaft 104 such that the leg spring 112 is inserted within the second body 144 of the second wheel-half 110, thereby torsionally coupling the first wheel-half 108 and the second wheel-half 110. FIG. 3D illustrates the bearing sleeve 114 affixed to the sensor shaft 104. FIG. 3E illustrates the first lock-aperture 158 of the first wheel-half 108 may be aligned with the second lock-aperture 160 of the second wheel-half 110 by rotating the second wheel-half 110 relative to the first wheel-half 108. FIG. 3F illustrates the locking the second wheel-half 110 to the first wheel-half 108 by the rotational lock 118. FIG. 3G illustrates the bearing 116 affixed to the bearing sleeve 114.

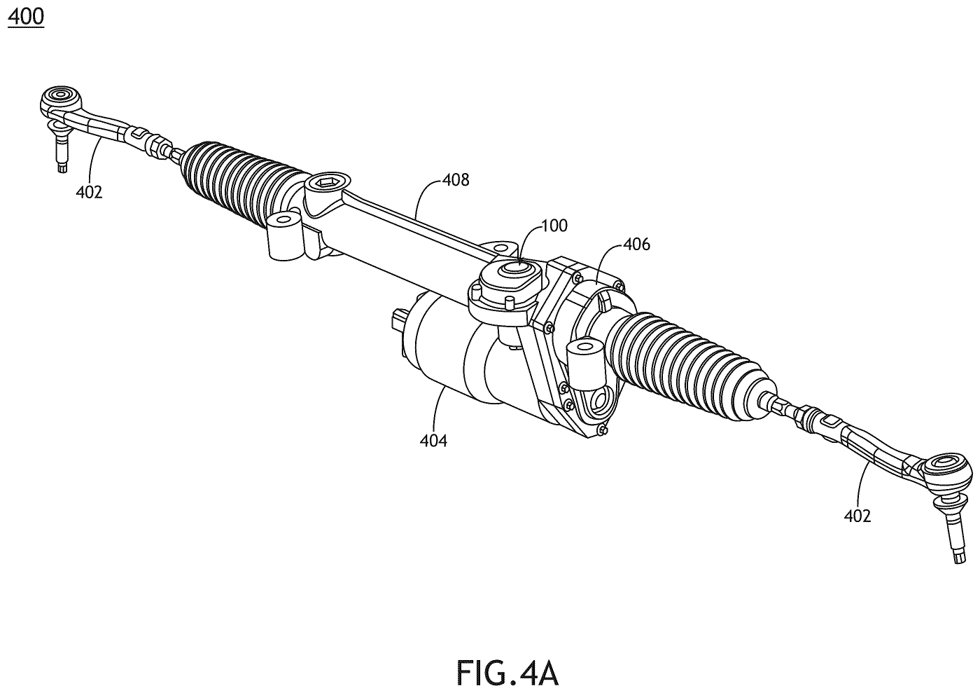

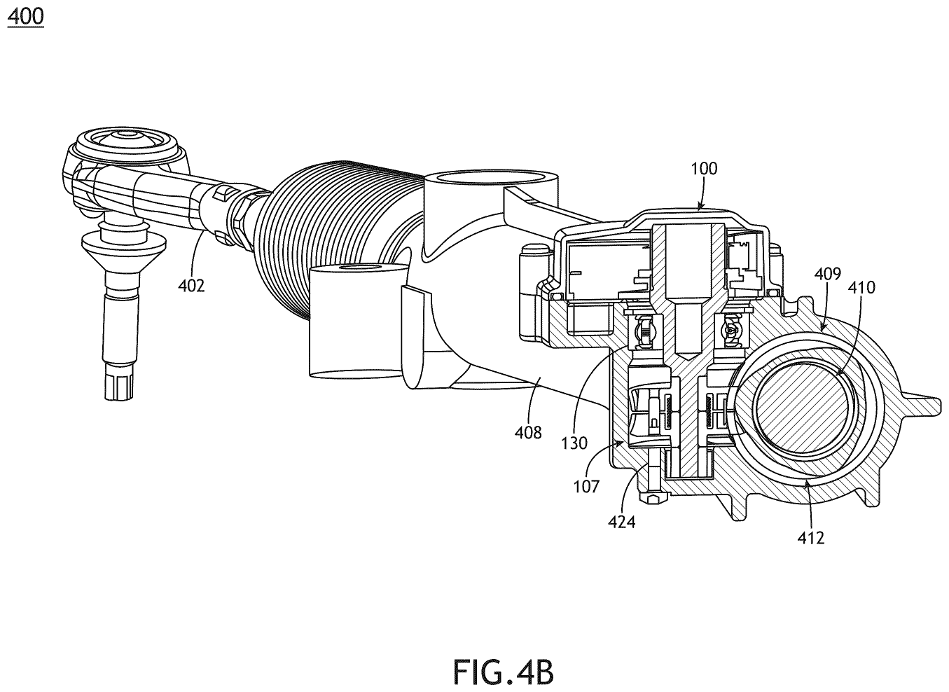

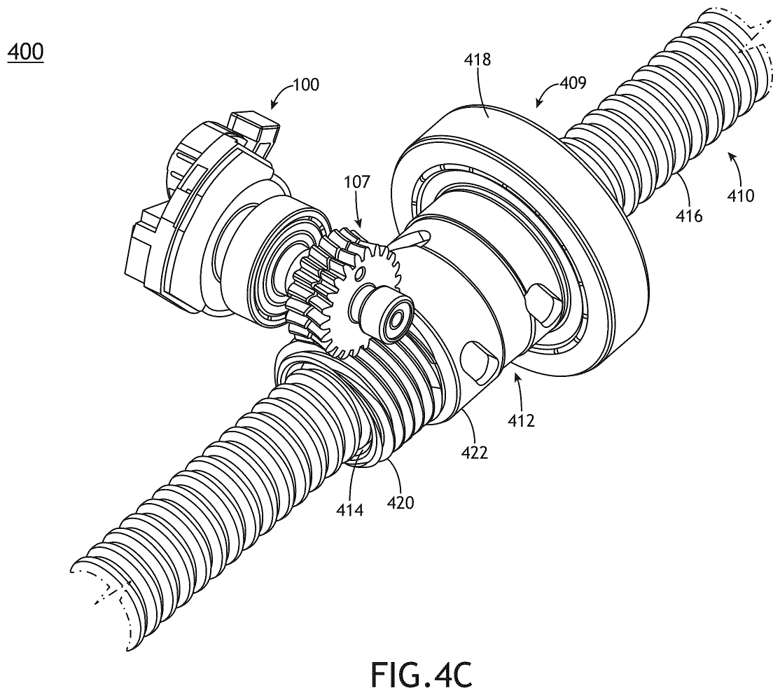

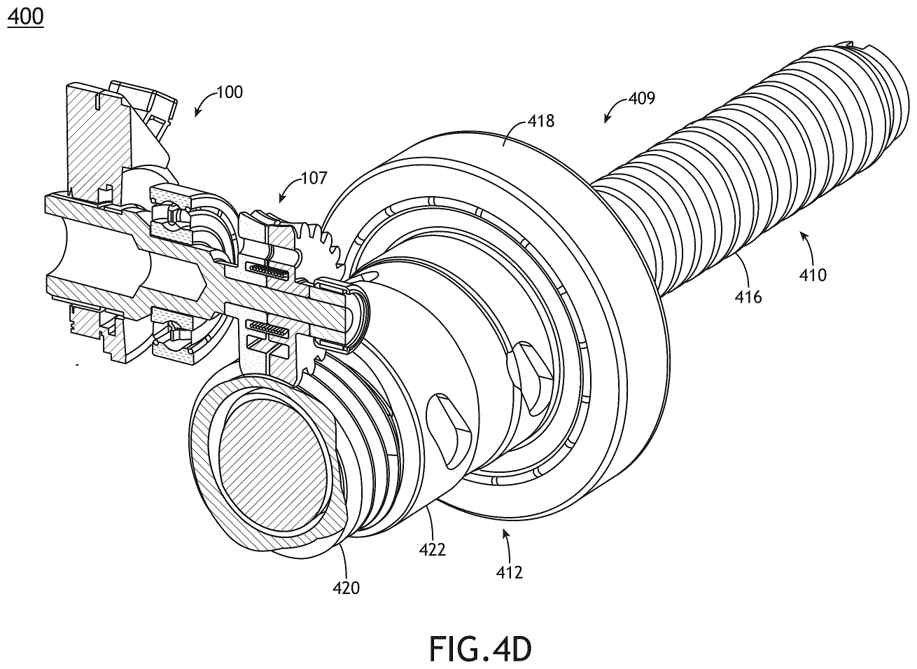

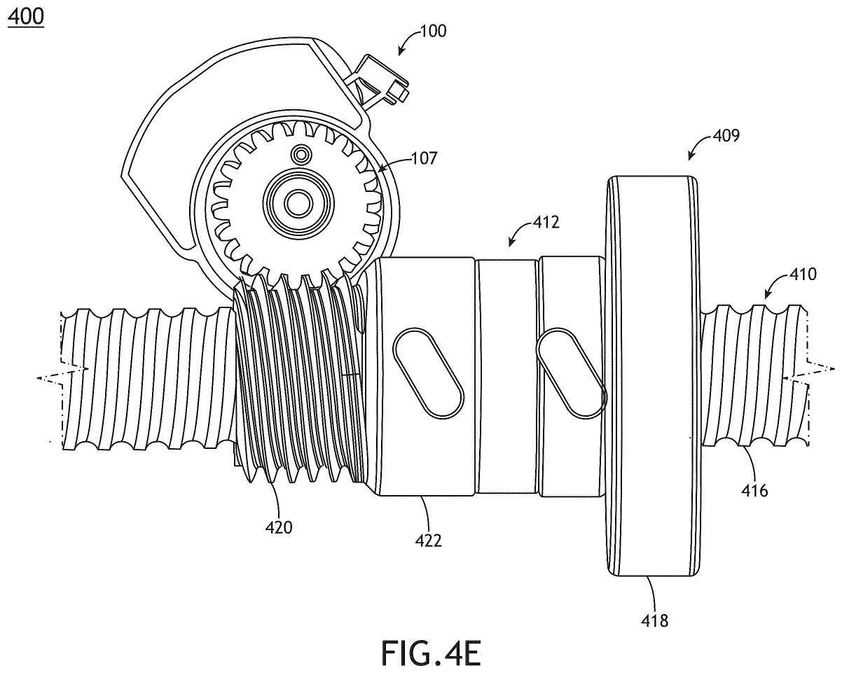

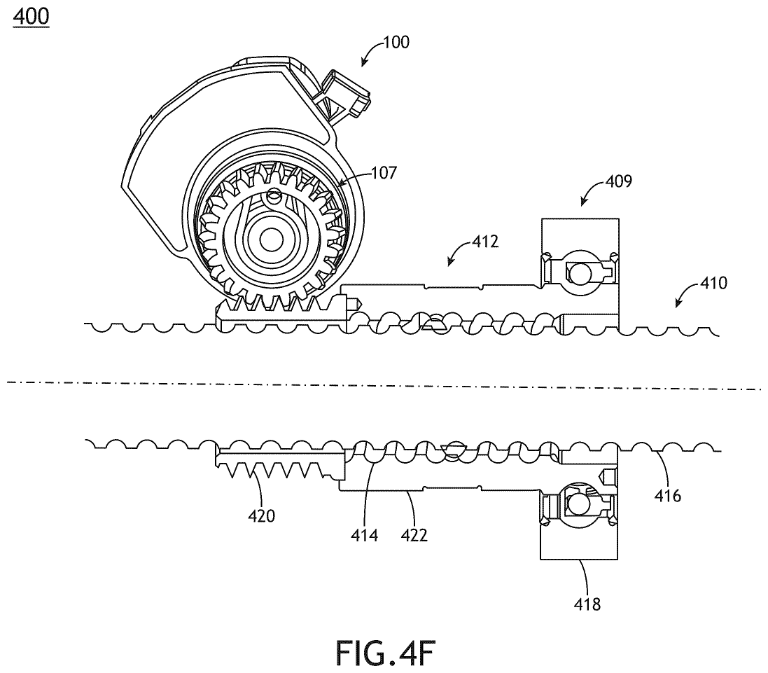

FIGS. 4A-4F illustrate a road wheel actuator 400, in accordance with one or more embodiments of the present disclosure. The road wheel actuator 400 may be a steering linkage, a screw-and-nut steering assembly, or the like. The road wheel actuator 400 may be a component of a power steering system (e.g., an electric power steering system). The road wheel actuator 400 may include the position sensor 100, tie rod ends 402, a motor 404, a transmission 406, a housing 408, a ball screw drive 409 (BSD), a ball screw spindle 410, and/or a ball screw nut 412.

The tie rod ends 402 may be configured to couple to a suspension of a vehicle.

The motor 404 may include an electric motor, a hydraulic motor, or the like.

The transmission 406 may be a belt drive system, a gear system, or the like. For example, the transmission 406 may be the belt drive system and may include one or more pulleys (not depicted).

The ball screw drive 409 may include the ball screw spindle 410 and the ball screw nut 412.

The transmission 406 may rotationally couple the motor 404 and the ball screw drive 409. For example, the transmission 406 may rotationally couple the motor 404 and the ball screw nut 412 of the ball screw drive 409. The ball screw nut 412 can be configured to receive torque from the transmission 406. Torque may be applied from the motor 404 via the transmission 406 to the ball screw nut 412. Torque may be applied to the ball screw nut 412 by the motor 404 to translate the ball screw spindle 410 relative to the ball screw nut 412.

The ball screw nut 412 may include internal nut-threads 414, a nut-bearing 418, external nut-threads 420, and/or a drive section 422. The internal nut-threads 414 may run along the length of the ball screw nut 412. The nut-bearing 418 and the external nut-threads 420 may be disposed at opposing ends of the ball screw nut 412. The drive section 422 may be disposed between the nut-bearing 418 and the external nut-threads 420.

The transmission 406 may rotationally couple the motor 404 and the drive section 422 of the ball screw nut 412. The drive section 422 of the ball screw nut 412 may be driven by the transmission 406. For example, the transmission 406 may include a belt drive, a chain drive, a gear drive, or a direct drive (e.g., a hollow shaft motor arranged coaxial to the drive section 422) which may drive the drive section 422. Thus, the drive section 422 may cause rotation of the ball screw nut 412 about a central axis.

The nut-bearing 418 may be disposed at a first end of the ball screw nut 412. An outer ring of the nut-bearing 418 may be press fit into the housing 408. The ball screw nut 412 may be axially constrained to the housing 408 by the nut-bearing 418. The ball screw nut 412 may be prevented from translating relative to the housing 408. The ball screw nut 412 may be supported by the housing 408 with one-degree of freedom. The ball screw nut 412 and the housing 408 may form a revolute joint. The housing 408 may be configured to rotate relative to the housing 408.

The ball screw spindle 410 may include external spindle-threads 416. The external spindle-threads 416 may be a worm, a screw, or the like.

The internal nut-threads 414 of the ball screw nut 412 may couple to the external spindle-threads 416 of the ball screw spindle 410. The ball screw spindle 410 may be configured to rotate relative to the ball screw nut 412. Rotation of the ball screw spindle 410 relative to the ball screw nut 412 may cause the translation of the ball screw spindle 410 relative to the ball screw nut 412 and/or relative to the housing 408. The linear translation of the ball screw spindle 410 may be facilitated by contact between internal nut-threads 414 of the ball screw nut 412 and external spindle-threads 416 of the ball screw spindle 410. Thus, rotary motion of the ball screw nut 412 may be translated to linear motion of the ball screw spindle 410. A direction in the ball screw spindle 410 translates may be based on the direction of rotation of the ball screw nut 412 and/or a handedness of the external spindle-threads 416.

The ball screw drive 409 may also include balls (not depicted) which are radially arranged between the internal nut-threads 414 of the ball screw nut 412 and the external spindle-threads 416 of the ball screw spindle 410. The balls may recirculate within the ball screw nut 412 via one or more ball return tubes (not depicted).

The housing 408 may house the ball screw spindle 410. The ball screw spindle 410 may be configured to translate relative to the housing 408.

The tie rod ends 402 may couple to opposing ends of the ball screw spindle 410. The translation of the ball screw spindle 410 may translate the tie rod ends 402. The translation of the tie rod ends 402 may adjust a steering of a vehicle.

The external nut-threads 420 may be a worm, a screw, or the like.

The external nut-threads 420 may engage the sensor wheel 107 of the position sensor 100. The external nut-threads 420 may engage the sensor wheel 107 of the position sensor 100 such that rotation of the ball screw nut 412 by the motor 404 drivably rotates the sensor wheel 107 about a central axis. For example, the external nut-threads 420 may engage the first teeth 134 of the first wheel-half 108 and the second teeth 146 of the second wheel-half 110. The sensor wheel 107 may be rotatably driven by the external nut-threads 420 of the ball screw nut 412. For example, the first wheel-half 108 and/or the second wheel-half 110 may be rotatably driven by the external nut-threads 420 of the ball screw nut 412.

The rotation of the first wheel-half 108 may rotate the sensor shaft 104 and/or the sensor sleeve 138 of the angle sensor 102. Thus, the angle sensor 102 may measure the rotations of the ball screw nut 412, and correspondingly the rotation and linear translation of the ball screw spindle 410. The angular position of the sensor shaft 104 may determine the linear position of the ball screw spindle 410. The linear position of the ball screw spindle 410 can be obtained via the position sensor 100 that fulfills the role of a rotational angle position sensor (or rotary position sensor).

The housing 408 may house the position sensor 100. The outer ring 130 of the bearing 106 may be press fit into the housing 408. One or more components of the position sensor 100 may be axially constrained to the housing 408 by the bearing 106. For example, one or more of the angle sensor 102, the sensor shaft 104, the bearing 106, the sensor wheel 107, the first wheel-half 108, the second wheel-half 110, the leg spring 112, the bearing sleeve 114, the bearing 116, and/or the rotational lock 118 may be axially constrained to the housing 408. The sensor sleeve 138 of the angle sensor 102 may or may not be axially constrained to the housing 408. The sensor sleeve 138 may be configured to move axially for tolerancing.

The housing 408 may include a bore 424. The bore 424 may be aligned with the rotational lock 118, the first lock-aperture 158, and/or the second lock-aperture. The rotational lock 118 may be accessible for locking and unlocking the sensor wheel 107 via the bore 424.

When the rotational lock 118 unlocks the sensor wheel 107, the first wheel-half 108 and the second wheel-half 110 may rotate in opposite directions until the first teeth 134 and second teeth 146 engage opposite flanks of a thread amongst the external nut-threads 420 of the ball screw nut 412. The leg spring 112 may cause the first teeth 134 and second teeth 146 to eliminate gear-lash with the external nut-threads 420. Such a spring-like engagement provides zero-lash between the sensor wheel 107 and the external nut-threads 420 of the ball screw nut 412. The zero gear-lash may be beneficial for precise position sensing of the rotation of the ball screw nut 412, together with a corresponding rotation and linear translation of the ball screw spindle 410. Zero gear-lash may be beneficial for an exact position detection and signal.

The first teeth 134 and the second teeth 146 of the sensor wheel 107 may be designed with enough clearance to handle the given tolerances and bending. The first teeth 134 and the second teeth 146 may include small flank/pressure-angles as low as 12° less while providing the zero gear-lash.

The ball screw nut 412 may be integrally formed with the external nut-threads 420 and the drive section 422. Alternatively, the external nut-threads 420 may be affixed to the drive section 422 of the ball screw nut 412 as a separate sleeve. For example, the external nut-threads 420 may be affixed as a separate sleeve via press fit, clamping, screwing, welding (e.g., laser welding), or the like. The external nut-threads 420 may include a different material than the drive section 422 where the external nut-threads 420 are the separate sleeve. For example, the drive section 422 may be a steel material and the external nut-threads 420 may be a non-steel material, where the non-steel material may provide improved friction/wear properties with the sensor wheel 107.

The external nut-threads 420 may include one or more starts. For example, the external nut-threads 420 may include two or more starts. The external nut-threads 420 may be a multi-start thread where the external nut-threads 420 include two or more starts. The first teeth 134 and the second teeth 146 of the sensor wheel 107 may engage to one or more of the external nut-threads 420. Where the external nut-threads 420 are a multi-start thread, the first teeth 134 and the second teeth 146 may include a wider range of gear module and number of teeth and therefore resulting in a favorable wheel diameter. The multi-start thread may enable utilization of the measuring range of the position sensor 100, further increasing the accuracy.

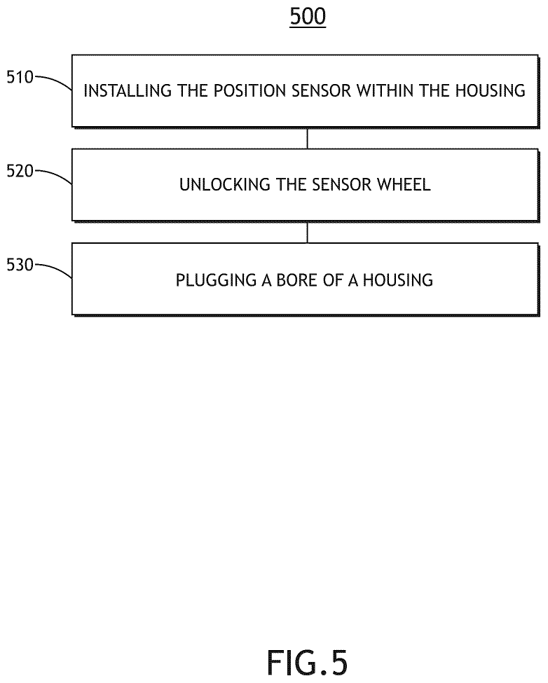

FIG. 5 illustrates a flow diagram of a method 500, in accordance with one or more embodiments of the present disclosure. The method 500 provides a method for installing the position sensor 100 in the road wheel actuator 400. The embodiments and the enabling technology described previously herein in the context of the position sensor 100 and the road wheel actuator 400, should be interpreted to extend to the method. It is further recognized, however, that the method is not limited to the position sensor 100 and the road wheel actuator 400.

In a step 510, a position sensor may be installed within a housing. For example, the position sensor 100 may be installed within the housing 408. The housing 408 may house the position sensor 100. The outer ring 130 of the bearing 106 may be press fit into the housing 408. The position sensor 100 may be installed within the housing 408 such that the sensor wheel 107 may engage the external nut-threads 420 of the ball screw nut 412.

The sensor wheel 107 may be locked while installing the position sensor 100 may be installed within the housing 408. The rotational lock 118 may be disposed within the first lock-aperture 158 and the second lock-aperture 160, thereby locking the sensor wheel 107. For example, the rotational lock 118 may lock the rotational lock 118 to enable meshing the external nut-threads 420 with both the first teeth 134 and the second teeth 146.

In a step 520, the sensor wheel may be unlocked. For example, the sensor wheel 107 may be unlocked. The sensor wheel 107 may be unlocked by removing the rotational lock 118 from at least one of the first lock-aperture 158 and the second lock-aperture 160. When the rotational lock 118 unlocks the sensor wheel 107, the first wheel-half 108 and the second wheel-half 110 may rotate in opposite directions until the first teeth 134 and second teeth 146 engage opposite flanks of a thread amongst the external nut-threads 420 of the ball screw nut 412.

The sensor wheel 107 may be rotated via rotation of the ball screw nut 412 so that the bore of the housing 408 aligns with the second lock-aperture 160 of the second wheel-half 110. The rotational lock 118 may be unlocked via the bore 424 of the housing 408. For example, a tool may be inserted through the bore 424 and the second lock-aperture 160 up to the rotational lock 118. The tool may drive the rotational lock 118 forwards and/or backwards such that rotational lock 118 exits the rotationally releases the second wheel-half 110 from the first wheel-half 108.

In an example embodiment, the rotational lock 118 may be disposed in one of the first lock-aperture 158 of the first wheel-half 108 or the second lock-aperture 160 of the second wheel-half 110 after unlocking the sensor wheel 107. For instance, the rotational lock 118 screwed completely into the first lock-aperture 158 of the first wheel-half 108 or completely into the second lock-aperture 160 of the second wheel-half 110.

In a further example embodiment, the rotational lock 118 may be removed from both the first lock-aperture 158 of the first wheel-half 108 and the second lock-aperture 160 of the second wheel-half 110 after unlocking the sensor wheel 107.

In a step 530, the bore may be plugged. For example, the bore 424 may be plugged. The bore 424 may be plugged by a plug, screw, bolt, rivet, or the like.

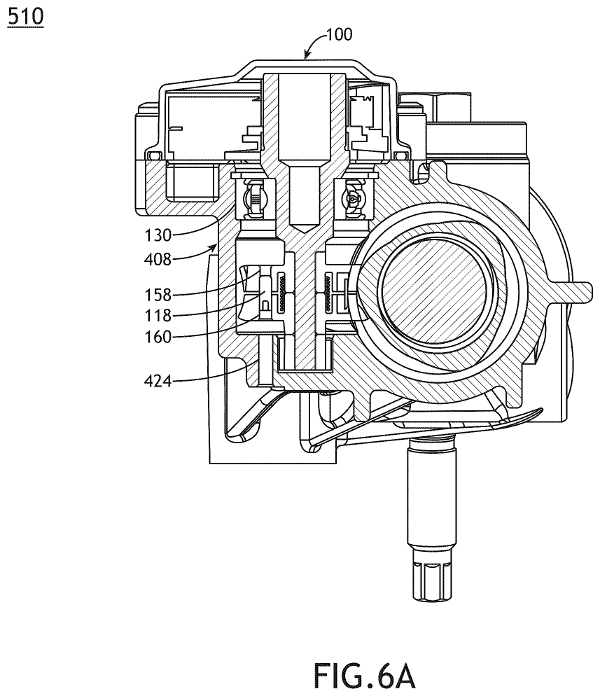

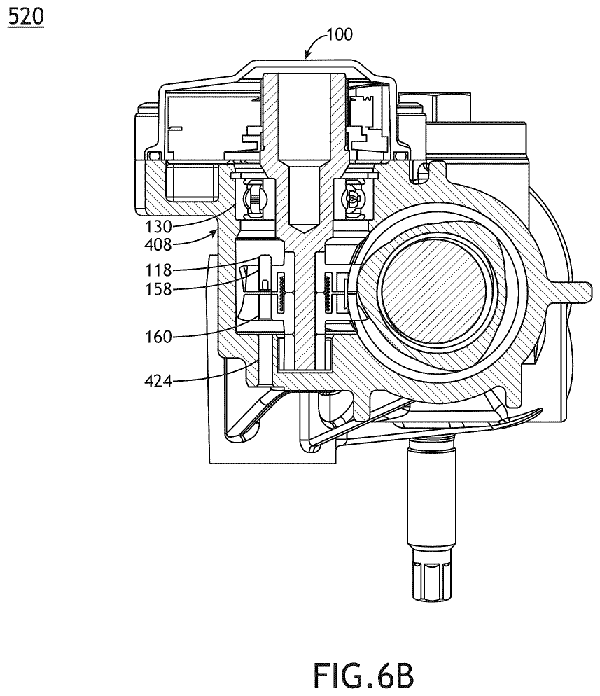

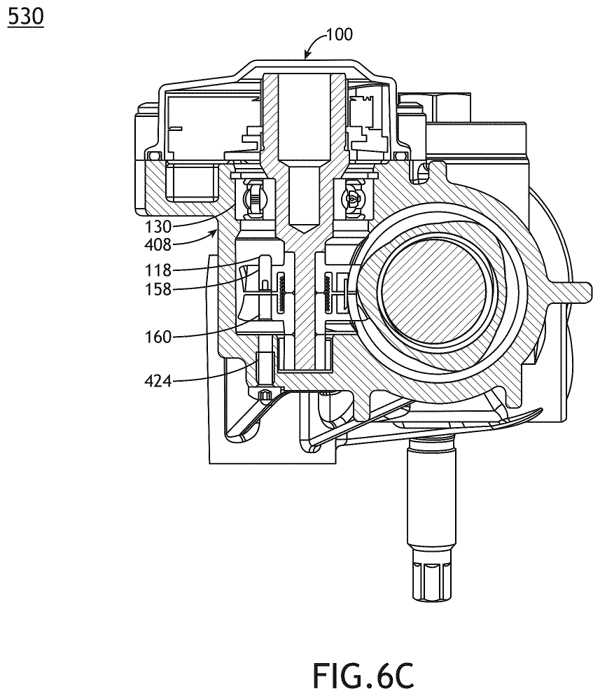

The method 500 may be further understood with reference to FIGS. 6A-6C. FIG. 6A illustrates installing the position sensor 100 within the housing 408. FIG. 6B illustrates unlocking the sensor wheel 107 by driving the rotational lock 118 into the first lock-aperture 158 of the first wheel-half 108. FIG. 6C illustrates plugging the bore 424 of the housing 408.

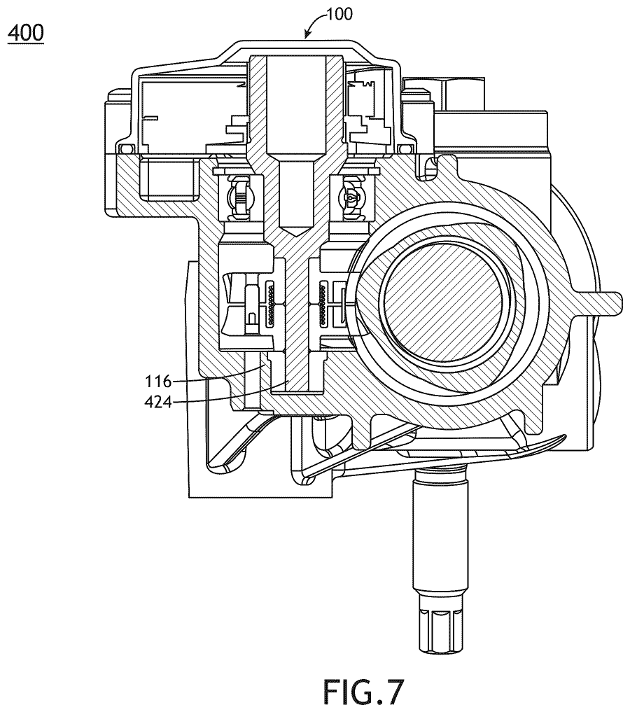

FIG. 7 illustrates the road wheel actuator 400 and the position sensor 100, in accordance with one or more embodiments of the present disclosure. Although the position sensor 100 is described as including the bearing sleeve 114, this is not intended as a limitation of the present disclosure. The bearing 116 may affix directly to the sensor shaft 104 (e.g., without the bearing sleeve 114). For example, the bearing 116 may affix directly to the smooth shaft-section 126 of the sensor shaft 104. Furthermore, although the bearing 116 is described as a needle bearing, this is not intended as a limitation of the present disclosure. As illustrated in this example, the bearing 116 may be plain bushing.

Although the position sensor 100 is described as including the leg spring 112, this is not intended as a limitation of the present disclosure. It is contemplated that the first wheel-half 108 and/or the second wheel-half 110 may include an elastic spring feature (not depicted). The elastic spring feature may provide a rotational pre-loading of the first wheel-half 108 and the second wheel-half 110. The elastic spring feature may be installed (or overmolded) within the first wheel-half 108 and/or the second wheel-half 110.

Although the position sensor 100 is described as including the rotational lock 118, this is not intended as a limitation of the present disclosure. It is contemplated that the sensor wheel 107 may include an integrated elastic finger (not depicted). The integrated elastic finger may be configured to lock and unlock the sensor wheel 107. The integrated elastic finger may include an elastic feature of one of the wheel-halves that engages another feature of the other wheel-halves. After torsional preloading the wheels into the correct alignment the integrated elastic finger of the first wheel-108 may be elastically bent (by using a tool/pin) until the finger axially engages into a window/notch of the second wheel-half 110. The torsional load may lock the sensor wheel 107 and preventing the finger from snapping back. After assembly into the housing the elastic finger may be released, thereby unlocking the sensor wheel 107.

The position sensor 100 may be utilized within mechanical power-assisted steering systems or steer-by-wire systems, which can be present within manual or autonomous vehicles. The position sensor 100 may be utilized within front, rear, or all-wheel steering systems. The position sensor 100 may be suitable for any front- and rear-wheel steering actuators which use a ball nut screw.

The position sensor 100 may generate an electric signal to control (or feedback control) or supervise steering function or to adjust an additional steering position sensor. The data from the position sensor 100 may be used by a steer-by wire system, such as an autonomous system. For a steer-by-wire systems the rack position of the road wheel actuator must be highly accurate. The road wheel actuator 400 may have low rack push-through-forces to provide the best possible feedback to the driver.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for applications.

### LIST OF REFERENCE NUMBERS

100 position sensor
102 angle sensor
104 sensor shaft
106 bearing
107 sensor wheel
108 first wheel-half
110 second wheel-half
112 leg spring
114 bearing sleeve
116 bearing
118 rotational lock
120 body section
122 shoulder
124 knurled shaft-section
126 smooth shaft-section
128 inner ring
130 outer ring
132 first body
134 first teeth
136 sensor housing
138 sensor sleeve
140 first coil-well
142 first leg-catch
144 second body
146 second teeth
148 second coil-well
150 second leg-catch
152 first leg
154 second leg
156 coil
158 first lock-aperture
160 second lock-aperture
162 first travel-well
164 second travel-well
166 first shaft-hole
168 second shaft-hole
200 method
210 step
220 step
230 step
240 step
250 step
260 step
270 step
280 step
290 step
400 road wheel actuator
402 tie rod ends
404 motor
406 transmission
408 housing
409 ball screw drive
410 ball screw spindle
412 ball screw nut
414 internal nut-threads
416 external spindle-threads
418 nut-bearing
420 external nut-threads
422 drive section
424 bore
500 method
510 step
520 step
530 step

What is claimed:

1. A position sensor comprising:
an angle sensor;
a sensor shaft, wherein the sensor shaft is configured to rotate relative to the angle sensor, wherein the angle sensor is configured to sense rotation of the sensor shaft;
a first bearing, wherein the first bearing is affixed to the sensor shaft; and
a sensor wheel comprising:
a first wheel-half, wherein the first wheel-half comprises a first body and first teeth, wherein the first teeth radially extend from the first body, wherein the first wheel-half is affixed to the sensor shaft, wherein the sensor shaft is configured to rotate with the first wheel-half; and
a second wheel-half, wherein the second wheel-half comprises a second body and second teeth, wherein the second teeth radially extend from the second body, wherein the second wheel-half is directly or indirectly supported by the sensor shaft, wherein the second wheel-half is configured to rotate relative to the sensor shaft and the first wheel-half, wherein the second wheel-half is torsionally preloaded to the first wheel-half.

2. The position sensor of claim 1, the angle sensor comprising a sensor housing and a sensor sleeve, wherein the sensor sleeve is configured to rotate relative to the sensor housing, wherein the sensor sleeve is configured to sense the rotation of the sensor sleeve relative to the sensor housing, wherein the sensor shaft comprises a body section, wherein the body section is affixed to the sensor sleeve.

3. The position sensor of claim 1, the sensor shaft comprising a shoulder, wherein the first bearing is affixed to the shoulder.

4. The position sensor of claim 1, the sensor shaft comprising a knurled shaft-section, wherein the first body is affixed to the knurled shaft-section.

5. The position sensor of claim 1, the sensor shaft comprising a smooth shaft-section, wherein the second body is supported by the smooth shaft-section.

6. The position sensor of claim 1, wherein the first wheel-half is disposed between the first bearing and the second wheel-half.

7. The position sensor of claim 6, wherein the first bearing is disposed between the angle sensor and the sensor wheel.

8. The position sensor of claim 1, wherein the sensor shaft comprises a body section, a shoulder, a knurled shaft-section, and a smooth shaft-section, wherein the shoulder is disposed between the body section and the knurled shaft-section, wherein the knurled shaft-section is disposed between the shoulder and the smooth shaft-section.

9. The position sensor of claim 1, the sensor wheel comprising a leg spring, wherein the second wheel-half is torsionally preloaded to the first wheel-half through the leg spring.

10. The position sensor of claim 9, the leg spring comprising a first leg, a second leg, and a coil, wherein the coil connects the first leg and the second leg;
wherein the first wheel-half defines a first coil-well, a first leg-catch, and a first travel-well, wherein the first leg-catch and the first travel-well are disposed radially outwards of the first coil-well;
wherein the second wheel-half defines a second coil-well, a second leg-catch, and a second travel-well, wherein the second leg-catch and the second travel-well are disposed radially outwards of the second coil-well;
wherein the first leg is abutted to the first leg-catch and disposed in the second travel-well, wherein the second leg is abutted to the second leg-catch and disposed in the first travel-well, wherein the coil is disposed in the first coil-well and the second coil-well.

11. The position sensor of claim 10, wherein the first travel-well comprises an arcuate shape, wherein the first leg-catch is disposed between distal ends of the first travel-well;
wherein the second travel-well comprises an arcuate shape, wherein the second leg-catch is disposed between distal ends of the second travel-well.

12. The position sensor of claim 1, comprising a rotational lock, wherein the rotational lock is configured to lock the second wheel-half to the first wheel-half and unlock the second wheel-half from the first wheel-half.

13. The position sensor of claim 12, wherein the first body defines a first lock-aperture;
wherein the second body defines a second lock-aperture;
wherein the second wheel-half is configured to rotate relative to the first wheel-half to align the second lock-aperture with the first lock-aperture, wherein the second teeth are aligned with the first teeth when the second lock-aperture is aligned with the first lock-aperture,
wherein the rotational lock is configured to lock the second wheel-half to the first wheel-half by being disposed within the first lock-aperture and the second lock-aperture, wherein the rotational lock is configured to unlock the second wheel-half from the first wheel-half by being disposed within one of the first lock-aperture or the second lock-aperture.

14. The position sensor of claim 1, comprising a second bearing, wherein the second bearing is supported by the sensor shaft, wherein the second wheel-half is disposed between the first wheel-half and the second bearing.

15. The position sensor of claim 14, wherein at least one of first bearing or the second bearing comprises one of a needle bearing, a glide bushing, a ball bearing, or a plain bearing.

16. The position sensor of claim 14, comprising a bearing sleeve, wherein the bearing sleeve is affixed to the sensor shaft, wherein the bearing sleeve axially secures the second wheel-half, wherein the second bearing is supported by the sensor shaft via the bearing sleeve.

17. A road wheel actuator comprising:
a position sensor comprising:
an angle sensor;
a sensor shaft, wherein the sensor shaft is configured to rotate relative to the angle sensor, wherein the angle sensor is configured to sense rotation of the sensor shaft;
a first bearing, wherein the first bearing is affixed to the sensor shaft; and
a sensor wheel comprising:
a first wheel-half, wherein the first wheel-half comprises a first body and first teeth, wherein the first teeth radially extend from the first body, wherein the first wheel-half is affixed to the sensor shaft, wherein the sensor shaft is configured to rotate with the first wheel-half; and
a second wheel-half, wherein the second wheel-half comprises a second body and second teeth, wherein the second teeth radially extend from the second body, wherein the second wheel-half is directly or indirectly supported by the sensor shaft, wherein the second wheel-half is configured to rotate relative to the sensor shaft and the first wheel-half, wherein the second wheel-half is torsionally preloaded to the first wheel-half;
a housing; and
a ball screw drive comprising:
a ball screw spindle comprising external spindle-threads; and
a ball screw nut comprising internal nut-threads, a nut-bearing, external nut-threads, and a drive section, wherein the ball screw nut is axially constrained to the housing by the nut-bearing, wherein the internal nut-threads couple to the external spindle-threads, wherein rotation of the ball screw nut causes translation of the ball screw spindle relative to the ball screw nut and the housing, wherein the external nut-threads engage the first teeth and the second teeth.

18. The road wheel actuator of claim 17, comprising a motor and a transmission, wherein the transmission rotationally couples the motor and the drive section of the ball screw nut.

19. The road wheel actuator of claim 17, wherein the drive section is disposed between the nut-bearing and the external nut-threads.

20. A method comprising:
affixing a first bearing to a sensor shaft;
affixing a first wheel-half of a sensor wheel to the sensor shaft, wherein the first wheel-half comprises a first body and first teeth, wherein the first teeth radially extend from the first body, wherein the sensor shaft is configured to rotate with the first wheel-half;
inserting a second wheel-half of the sensor wheel onto the sensor shaft, wherein the second wheel-half comprises a second body and second teeth, wherein the second teeth radially extend from the second body, wherein the second wheel-half is directly or indirectly supported by the sensor shaft, wherein the second wheel-half is configured to rotate relative to the sensor shaft and the first wheel-half, wherein the second wheel-half is torsionally preloaded to the first wheel-half; and
inserting the sensor shaft within an angle sensor to form a position sensor, wherein the sensor shaft is configured to rotate relative to the angle sensor, wherein the angle sensor is configured to sense rotation of the sensor shaft.
